(19) United States
(12) Patent Application Publication
(10) Pub. No.: US 2014/0361861 A1
(43) Pub. Date: Dec. 11, 2014

(54) Radial Drop Winding For Open-Wound Medium Voltage Dry Type Transformers

(71) Applicant: ABB Technology AG, Zurich (CH)

(72) Inventors: Robert C. Ballard, Wytheville, VA (US); Ryan Christian Tyler Alkire, Christiansburg, VA (US); Charles W. Johnson, Jr., Wytheville, VA (US); Charlie H. Sarver, Rocky Gap, VA (US)

(21) Appl. No.: 13/914,669

(22) Filed: Jun. 11, 2013

(51) Int. Cl. H01F 5/02; H01F 41/06

(52) U.S. Cl. CPC H01F 5/02; H01F 41/0641
USPC 336/222; 242/433

(57) ABSTRACT

A method provides a medium voltage radial drop winding for an open wound transformers. The method arranges a plurality of non-electrically conductive supports to extend outwardly from a periphery of an imaginary geometric shape so as to define an interior space. Each support includes a pair of opposing legs disposed in spaced relation and a bottom leg coupling the opposing legs to define at least one elongated slot between the opposing legs. Each slot has an open end. Conductive wire is dropped into the open end of each of the slots to substantially fill the slots and define at least one generally cylindrical winding segment carried by the supports.

### FIELD

The invention relates to dry type transformers and, more particularly, to a radial drop winding for open wound medium voltage dry type transformers.

### BACKGROUND

Dry type transformer windings incorporate a conductor, typically of aluminum or copper, and solid insulation to prevent dielectric failure. There are multiple conventional methods to control the geometry of these transformers to keep labor and material cost as low as possible. One of the metrics to determine material content is the fill factor or the amount of space inside a coil used for the conductor.

Radial drop winding techniques are typically used with coils that are vacuum cast using removable metal molds to hold the windings in place until the epoxy is rigid enough to support the mechanical forces.

Thus, there is a need to provide a radial drop winding for open wound/ventilated coils without relying on the vacuum cast or resin encapsulated process.

### SUMMARY

An object of the invention is to fulfill the need referred to above. In accordance with the principles of the present invention, this objective is obtained by a method that provides a medium voltage radial drop winding for an open wound transformers. The method arranges a plurality of non-electrically conductive supports to extend outwardly from a periphery of an imaginary geometric shape so as to define an interior space. Each support includes a pair of opposing legs disposed in spaced relation and a bottom leg coupling the opposing legs to define at least one elongated slot between the opposing legs. Each slot has an open end. Conductive wire is then dropped into the open end of each of the slots to substantially fill the slots to define at least one generally cylindrical winding segment carried by the supports.

In accordance with another aspect of the disclosed embodiment, a radial drop winding for an open wound transformers includes a plurality of non-electrically conductive supports, each support being constructed and arranged to extend outwardly from a periphery of an imaginary geometric shape so as to define an interior space. Each support includes a pair of opposing legs disposed in spaced relation and a bottom leg coupling the opposing legs to define at least one elongated slot between the opposing legs. At least one generally cylindrical winding segment comprising conductive wire is disposed in each slot so as to be carried by the supports.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a perspective view of the medium voltage radial drop winding including wire dropped vertically into a mechanical support structure in accordance with an embodiment of the invention.

FIG. 2 is a perspective view of the medium voltage radial drop winding of FIG. 1, but shown with the wire removed.

FIG. 3 is a perspective view of a mechanical support of the support structure of the medium voltage radial drop winding of FIG. 2.

### DETAILED DESCRIPTION OF AN EXEMPLARY EMBODIMENT

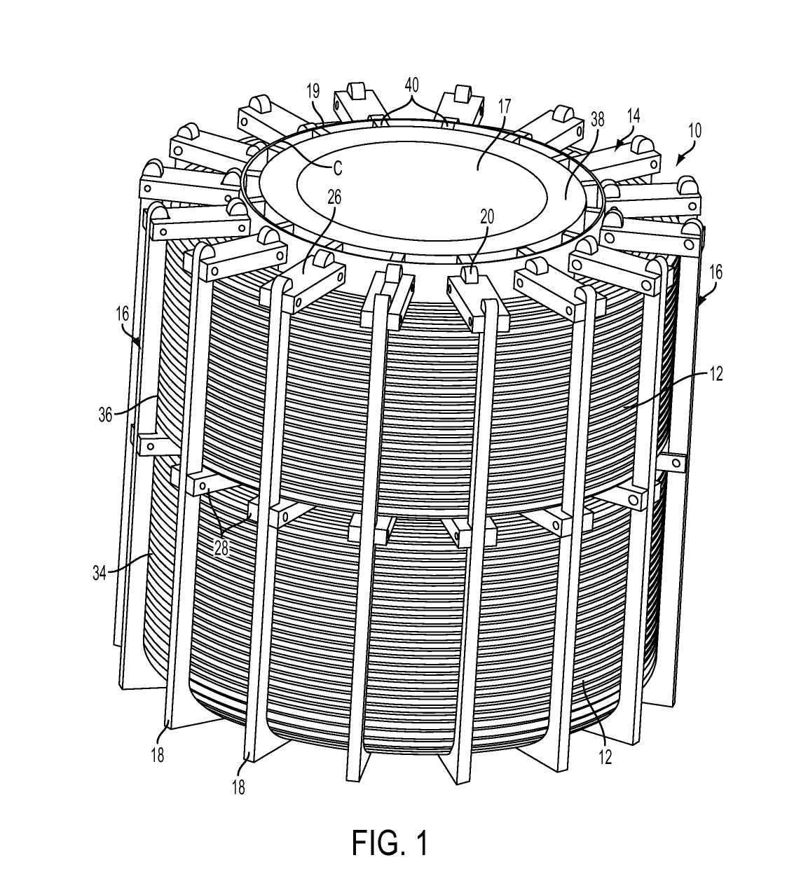

With reference to FIG. 1, a radial drop winding, generally indicated at 10, is shown for open wound transformers in accordance with an embodiment. The radial drop winding uses round wire 12 dropped vertically into a non-conductive mechanical support structure, generally indicated at 14.

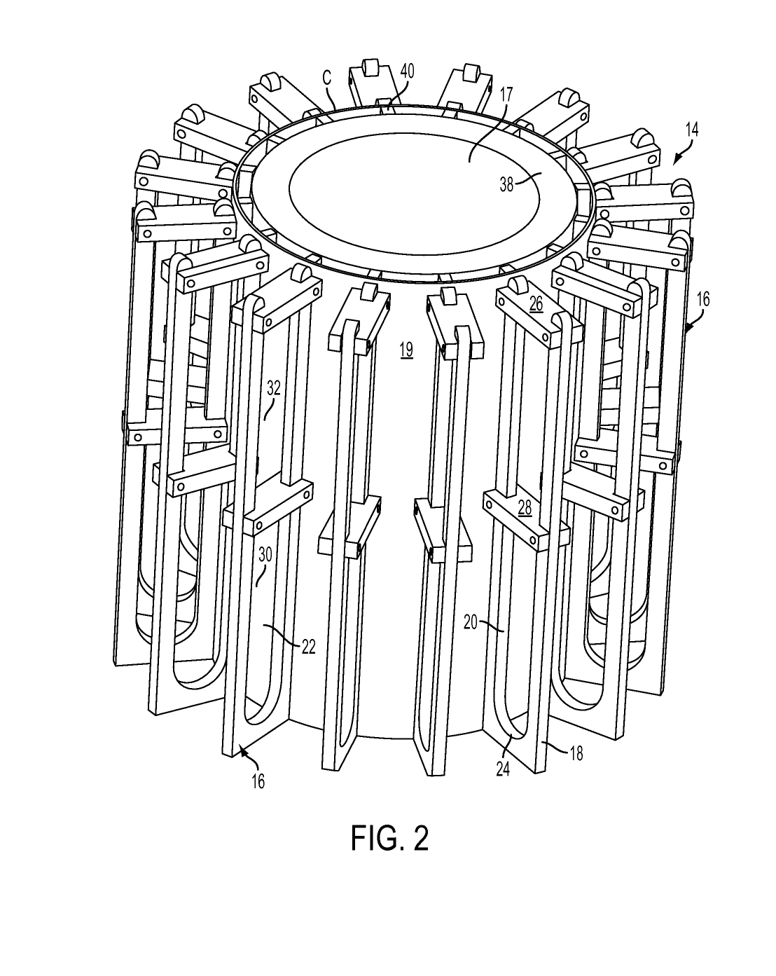

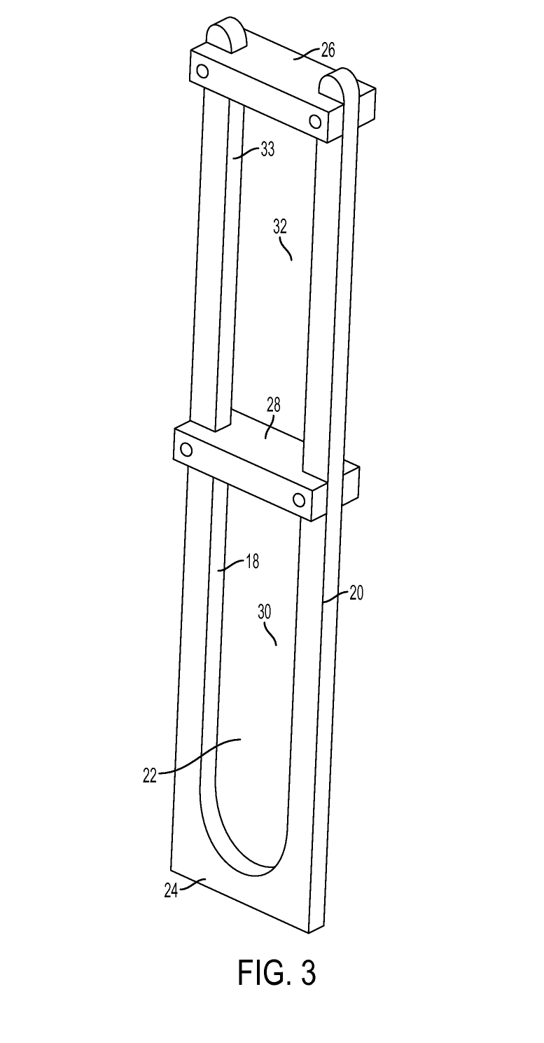

With reference to FIGS. 2 and 3, the support structure 14 comprises a plurality of mechanical supports, generally indicated at 16. Each support 16 is arranged to extend outwardly from a periphery of an imaginary geometric shape such as a circle C, so as to define an interior space 17. Other geometrical shapes can be used instead of circle C, such as a rectangle, square, octagon, hexagon, oval, etc. The separate supports 16 can be connected by tape or the like. Alternatively, the support structure 14 can be of unitary construction. Preferably, the supports 16 are spaced evenly around the periphery of the circle C. In the embodiment of FIG. 2, the supports 16 are arranged around a periphery of a conventional cylindrical HiLo barrier 19 that is provided for dielectrics and cooling.

As best shown in FIG. 3, each support 16 is made preferably from non-electrically conductive material such as polyester glass and includes a pair of opposing legs 18 and 20 in spaced relation and a fixed bottom leg 24, coupling the opposing legs 18 and 20, to define at least one generally U-shaped elongated slot 22 between the legs 18 and 20. A removable top leg 26 that opposes the bottom leg 24 is also provided, the function of which will be explained below. In the embodiment, each support 16 includes a removable central leg 28 that can be placed anywhere between the legs 18 and 20 and then fixed thereto, to divide the elongated slot 22 into first and second slots 30, 32, respectively.

With the top leg 26 and the central leg 28 removed from each support 16, during an open winding process, the drop winding conductor or wire 12 will fall into the open end 33 of each elongated slot 22 to rest on the bottom leg 24. The slot size is selected to control the radial and vertical build while limiting the probability that a turn could drop down the slot 22 and cause a higher than designed dielectric stress from turn to turn. The wound wire 12 builds from the bottom leg 24 upwardly and the turns of wire 12 will fall from the top to the bottom in a partially random fashion to substantially fill the slot 22 between the legs 18 and 20 to form a generally cylindrical winding.

In the embodiment shown in FIG. 2, the winding is optionally divided at least two more generally cylindrical segments 34 and 36 to allow for voltage adjustment taps supported off of a mechanical tap box (not shown). Once the lower winding segment 34 is completed, the central leg 28 is positioned between the legs 18 and 20 at the desired location above the winding segment 34 and then is fixed to the legs 18 and 20 by pins, adhesive, detents, or other fixation methods. Thereafter, the upper winding segment 36 is created by dropping more of the wire 12 into the second slot 32 of each support 16 above the central leg 28.

Once all slots, e.g., 30 and 32, have been filled with the wire 12, the top leg 26 is coupled to each support 16 at the top of the elongated slot 22 to close the end 33 and prevent vertical motion of the windings during manufacturing, shipping, installation, energization or fault conditions.

In the embodiments of FIGS. 2 and 3, the medium voltage radial drop winding 10 is shown to be mechanically connected to a lower voltage, second or inner winding 38 during the manufacturing process. The inner winding 38 is disposed in the interior space 17. Optional insulating spacers 40 are provided between the barrier 19 and the inner winding 38 to help support the barrier 19. The medium voltage radial drop winding 10 need not be mechanically connected to the inner winding 38 during the manufacturing process. The disclosed concept can be used with the inner winding 38 connected or disconnected.

The support structure 14 ensures that the winding segment(s) hold a predictable shape and survive the manufacturing, shipping, installation, and energization processes.

This drop winding concept can be applied to medium voltage dry type transformers that use a dipped or sprayed varnish coating process for environmental protection and enhanced mechanical performance. It can be used with aluminum or copper windings, paper/film wrapped conductors or film coated conductors at voltages presently up to 36 kV and 2 MVA, although even higher distribution voltages and higher distribution MVAs are contemplated.

The medium voltage radial drop winding 10 for open wound/ventilated coils will reduce direct labor and increases the effective fill factor, while maintaining a nearly linear voltage distribution inside the winding. The open wound or open ventilated coils do not use solid epoxy to fill the space between the coils or turns in the same winding. The radial drop winding 10 solves the issue of how to apply radial drop windings on open wound transformers without relying the vacuum cast or resin encapsulated process.

Other advantages of the medium voltage radial drop winding 10 include reduced material content, does not require vacuum cast or resin encapsulated processes, reduces manufacturing time, enhances mechanical performance versus a typical open wound disk configuration, and reduces overall footprint and weight.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A radial drop winding for an open wound transformers comprising:
a plurality of non-electrically conductive supports, each support being constructed and arranged to extend outwardly from a periphery of an imaginary geometric shape so as to define an interior space, each support including a pair of opposing legs disposed in spaced relation and a bottom leg coupling the opposing legs to define at least one elongated slot between the opposing legs, and
at least one generally cylindrical winding segment comprising conductive wire disposed in each slot so as to be carried by the supports.

2. The winding of claim 1, wherein each support further comprises a top leg opposing the bottom leg to prevent vertical motion of the at least one winding.

3. The winding of claim 2, wherein each bottom leg is fixed and each top leg is removable with respect to the associated support.

4. The winding of claim 1, wherein the geometric shape is a circle and the supports are evenly spaced about the periphery of the circle.

5. The winding of claim 2, wherein a central leg is provided between the top and bottom legs of each support to divide each slot into first and second slots, a first generally cylindrical winding segment being provided in the first slot and second generally cylindrical winding segment being provided in the second slot.

6. The winding of claim 1, wherein each support is composed of polyester glass.

7. The winding of claim 1, wherein each slot is of generally U-shape.

8. The winding of claim 1, in combination with a second, lower voltage winding disposed in the interior space.

9. The combination of claim 8, further comprising a cylindrical barrier between the plurality of supports and the second winding.

10. A method of providing a radial drop winding for an open wound transformers, the method comprising the steps of:
arranging a plurality of non-electrically conductive supports to extend outwardly from a periphery of an imaginary geometric shape so as to define an interior space, each support including a pair of opposing legs disposed in spaced relation and a bottom leg coupling the opposing legs to define at least one elongated slot between the opposing legs, each slot having an open end, and
dropping conductive wire into the open end of each of the slots to substantially fill the slots and define at least one generally cylindrical winding segment carried by the supports.

11. The method of claim 10, wherein the method further provides a top leg on each support that opposes the bottom leg to prevent vertical motion of the at least one winding segment.

12. The method of claim 10, wherein the placing step includes:
placing the conductive wire into the open end of each slot to fill a portion of each slot to define a first generally cylindrical winding segment,
placing a central leg between the top and bottom legs of each support and above the first winding segment, and
placing more of the conductive wire in each slot above the central leg to define a second generally cylindrical winding segment.

13. The method of claim 12, wherein method further provides a top leg on each support that opposes the bottom leg.

14. The method of claim 10, further providing a second, lower voltage winding in the interior space.

15. The method of claim 14, further providing a cylindrical barrier between the plurality of supports and the second winding.

16. The method of claim 10, wherein the geometric shape is a circle and the supports are arranged to extend radially from a periphery of the circle.

17. The method of claim 16, wherein the supports are spaced evenly about the periphery of the circle.
